(19) United States
(12) Patent Application Publication
(10) Pub. No.: US 2015/0026245 A1
(43) Pub. Date: Jan. 22, 2015

(54) METHOD FOR PROVIDING A WEB-SERVICE OF A MOBILE WEB-SERVICE-PROVIDER

(71) Applicant: ToMM Apps UG (Haftungsbeschrankt), Wesel (DE)

(72) Inventor: Marc Jansen, Moers (DE)

(21) Appl. No.: 14/382,874

(22) PCT Filed: Feb. 20, 2013
(86) PCT No.: PCT/EP2013/053397

§ 371 Date: Sep. 4, 2014

(30) Foreign Application Priority Data
Mar. 5, 2012 (DE) 102012203463.3

(51) Int. Cl. H04L 29/08; G06F 17/30; H04L 29/06

(52) U.S. Cl. CPC H04L 67/10; H04L 67/42; G06F 17/30091
USPC 709/203

(57) ABSTRACT

The invention proposes a method for providing a web-service on a mobile device as a web-service provider (ws_provider). The method comprises in an embodiment a step of receiving a request for registering (reqRegService) a web-service from the mobile web-service provider (ws_provider), a step of registering the service (regService), a step of receiving a web-service-request (serviceReq) pertaining to the web-service from a web-service-client (ws_client), and a step of checking, whether a response (chkServiceReqRes) in respect to the web-service-request of the web-service-clients (ws_client) is available from the mobile web-service-provider (ws_provider), and if a response (serviceReqRes) is available forwarding the response (serviceReqRes) towards the web-service-client (ws_client). The method comprises also a step of receiving a request (reqServiceReq) by the mobile web-service-provider (ws_provider) whether a web-service-request (serviceReq) is available, and a step of checking (chkServiceReq), whether a web-service-request (serviceReq) of a web-service-client (ws_client) is available, which could not be responded, if a web-service-request (serviceReq) of a web-service-client (ws_client) which could not be responded is available, forwarding of the web-service-request (serviceReq) towards the mobile web-service-provider (ws_provider). In an alternative embodiment, the invention proposes a method for providing a web-service on a mobile device as a web-service provider (ws_provider). The method comprises a step of receiving a request for registering (reqRegService) a web-service from the mobile web-service provider (ws_provider), a step of registering the service (regService). The method also comprises a step of receiving a request (ServiceReq) from a web-service-client (ws_client), a step of sending an information (infServReq) relating to the presence of a web-service-request (serviceReq) towards the mobile web-service-provider (ws_provider) and in response thereto receiving a request (reqServiceReq) by the mobile web-service-provider (ws_provider) relating to the web-service-request (serviceReq), and a step of sending information relating to the web-service-request (serviceReq) towards the mobile web-service-provider (ws_provider) and in response thereto receiving a response towards said web-service-request (serviceReqRes) for forwarding towards said web-service-client (ws_client).

### BACKGROUND

Today, web-services are used to provide a methodology, which is able to provide platform-independent services. Web-services thereby mean processing of requests and returning of responses in the sense of a machine-to-machine interaction. However, these web-services require a direct access, i.e. they must be reachable in the data network without any efforts. Unfortunately, however, web-services on mobile communication terminals are not standardized so far. This is because various problems may occur when a service on such a mobile device is to be offered.

One of the biggest problems of web-services on mobile communication terminals arises from the fact that such mobile devices quite often change their network respectively their location. Therefore, the web-service, which will be provided by such a device, is usually not available via a fix address resulting in a wide range of issues on the side of the service requestor of such a mobile web-service. In addition such mobile web-services are also usually not permanent (so-called 24/7 availability) available, because the mobile communication terminal offering such a mobile web-service may be in the meantime without network coverage or may also be disabled by their users. As a result, such mobile web-service may not only be accessible via a variety of different network addresses but may also be temporarily not available.

It would therefore be desirable to find a solution, which allows for providing such web-services also for mobile devices and also account for the above mentioned problems.

The number of mobile communication terminals is increasing in the last years and comprises not only powerful mobile computers such as tablets, net- and notebooks, but also mobile terminals. According to IDC-information dated 2011 about 300 millions Smartphone are existing showing a rapid increase. In particular in respect to the used operating system of these Smartphones numerous heterogeneous devices are represented. At the moment substantially five different operating systems are prevalent, e.g. Symbian OS, Android, iOS, Blackberry and Windows Mobile, whereby each of the operating system may be found in different versions and functional scope of operation. It is therefore an almost indomitable challenge to provide an operating system specific web-service for each platform in all their versions.

Therefore, it would be desirable having a platform-independent mechanism for service communication, to thereby avoid the necessity of implementing any service for any of the aforementioned operating systems.

### SUMMARY OF THE INVENTION

It is a target of the invention to avoid at least some of the aforementioned disadvantages and to provide a method for providing a web-service on a mobile device as a web-service provider.

The invention solves the above problem by providing a method for providing a web-service on a mobile device as a web-service provider. The method comprises a step of receiving a request for registering a web-service from the mobile web-service provider and a step of registering the service. Furthermore, the method comprises a step of receiving a web-service-request pertaining to the web-service from a web-service-client, and a step of checking, whether a response in respect to the web-service-request of the web-service-client is available from the mobile web-service-provider. If a response is available the response is forwarded in another step towards the web-service-client. Furthermore, a request originating from the mobile web-service-provider may be received in a further step whether a web-service-request is available. The method may check in a further step, whether a web-service-request of a web-service-client is available, which could not be responded. If a web-service-request of a web-service-client, which could not be responded, is available, the web-service-request is forwarded in another step towards the mobile web-service-provider.

The invention solves the above problem in an alternative embodiment by providing a method for providing a web-service on a mobile device as a web-service provider. The method comprises a step of receiving a request for registering a web-service from the mobile web-service provider, a step of registering the service. The method also comprises a step of receiving a request from a web-service-client, a step of sending an information relating to the presence of a web-service-request towards the mobile web-service-provider and in response thereto receiving a request by the mobile web-service-provider relating to the web-service-request, and a step of sending information relating to the web-service-request towards the mobile web-service-provider and in response thereto receiving a response towards said web-service-request for forwarding towards said web-service-client.

By use of the teaching according to the invention it is provided for the advantage that one or more web-service-requests of a web-service-client, which may not be answered immediately by the mobile web-service-provider, may be buffered, for that they may be transmitted towards the mobile web-service-provider once it notifies its presence again, i.e. the mobile web-service-provider is reachable again.

Therefore, it is no longer necessary, that a mobile web-service-provider is accessible via a network address in a 24/7 manner. Furthermore, a mobile web-service may also be requested even if the network address is changing as it happens frequently when using mobile communication terminals or if a mobile communication terminal is not logged in a network or is even switched off.

The method may thereby implemented in a so-called middleware, which may be a component of the mobile network or another fixed network which is connected thereto, whereby the middleware may be accessible via a known address, e.g. a public IP-Address.

Buffering of a web-service-request may thereby be accomplished exemplary by a central proxy-server for that it is not lost, and may be transmitted towards the mobile communication terminal which offers the respective web-service, once the respective mobile communication terminal has indicated its presence again towards the central proxy-server and requests availability of web-service-requests.

It is a further advantage, that the mobile Web-service-provider may communicate like a web-service-client with the dynamically generated web-service-proxy and thereby it is no longer necessary to implement server-side functionality within the respective mobile communication terminals. That is, looking from the network side it is no longer necessary to install a server-instance on the mobile communication terminal. Consequently, a web-service-client is not querying the web-service of the mobile web-service-provider directly, but queries a central accessible proxy. The web-service running on the mobile web-service-provider, queries in periodic or non-periodic intervals the proxy-server, whether there are new messages relating to the web-service.

Therefore, the problem of a potentially changing network address is resolved, since the mobile web-service-provider is acting like a client towards the proxy-server.

The central web-service-proxy may thereby exemplarily implement dynamically a proxy for any web-service used on a mobile Web-service-provider. Thereby, the implemented proxy may receive service-requests as a proxy of the actual service and may buffer these requests along with all necessary data pertaining thereto until the respective web-service of the mobile web-service-providers requests these requests at the respective proxy and receives there from these requests along with the necessary data pertaining thereto. Afterwards, the mobile web-service-provider may offer the respective web-service and may send a response towards the web-service-proxy, for that the web-service-proxy may forward the received responses towards the original requesting web-service-clients.

Such a response may be the result of a successful utilization of a web-service, as well as the web-service itself, respectively the data and application or apps that the web-service is offering or administering.

Web-services may encompass communication services as well as any other service, as well as data, applications, apps, result of calculation request, result of a position request, search results, etc.

Data, which is stored by the web-service-proxy-server, may be stored in a file, a relational database or in any other manner which allows for unique retrieval, such as an external database or an internal database.

Storing of data may be provided physically on the proxy-server itself as well as in a decentralized manner, e.g. in an external database server, a cloud or the like.

A mobile web-service-provider is preferably offered on a so-called Smartphone but may be any other mobile communication terminal, which is able to provide web-services, such as a non-touch-enabled mobile communication terminal or any other computer having dynamic addresses. Preferably a mobile web-service-provider is offered by a Smartphone or a mobile computer, e.g. in the form of a tablet, a notebook, a pad or similar. Such a mobile computer may also be embodied in an embedded system, which is mobile or fix with respect to a vehicle, e.g. a so-called On Board Unit (OBU) or a any other mobile communication terminal or, mobile computer, which is able to use a wireless radio-network or a fixed-network, preferably a WLAN network, a WiMAX-network or a WiFi-network, in particular a mobile communication network. A mobile communication network may encompass any mobile communication network such as a GSM, GSM-R, UMTS, LTE, iDEN-Network. In particular these mobile communication technologies may use networks of the second, third, fourth and future generation, and in more general also mobile communication technologies as they are used within the standards of DECT, Bluetooth, or WLAN. In addition also networks are encompassed, which may be used for “short-range-radio” or “ZigBee” or may be suitable for use therewith.

An important criterion for such a communication terminal or such a mobile computer is, that it may log into a network in which the network address may change frequently or is changing frequently, as it is true for mobile communication networks.

A web-service-client may thereby be any network-enabled computer, in particular a mobile communication terminal as described above.

Registering a web-service means that a web-service provided by a mobile web-service-provider is announced towards the central proxy-server, so that this central proxy-server may determine when receiving a request of a web-service-clients, which web-service is requested by the client and which mobile web-service-provider provides the web-service. Thereby different mobile web-service-provider may provide one and the same web-service as well as a mobile web-service-provider may provide a plurality of different web-services.

In a particular advantageous embodiment of the invention it is foreseen that the response is checked with respect to validity prior to being forwarded.

This provides the advantage that an outdated or otherwise no longer necessitated web-service-response is not forwarded towards the web-service-client.

In another particular advantageous embodiment of the invention it is foreseen that the response is checked with respect to temporal and/or spatial validity prior to being forwarded.

This provides the advantage that no invalid web-service-response is forwarded towards the web-service-client. Invalid may thereby be a spatial and/or temporal outdated web-service-response.

Thereby spatial validity means that depending on the position of the mobile web-service-provider a response may get invalid, if the actual position of the mobile web-service-providers when sending the response of the web-service-request of a client towards the middleware, is located outside a given area and thereby is rendered position-related irrelevant.

Temporal Validity Check may be based or example on a time stamp when using a proxy-server as middleware (so called lifetime), which is provided on the proxy. It may also exemplarily be a timeframe or the like while the web-service-request remains valid. Furthermore, a countdown may be determined, e.g. 20 min., until which the web-service-response is held to be relevant. It is also possible to provide a unique stamp, so that a web-service-response only is valid once, e.g. by setting the lifetime to 0. Thereby different realizations of validity and validity checks may be possible for a web-service-response, which all aim at ensuring that no invalid, i.e. outdated, web-service-responses are forwarded towards to the web-service-client.

It is also possible to implement such validity such that only web-service-requests which are not outdated and/or spatial invalid are forwarded towards the mobile web-service-provider, or in case that validity lapsed of the web-service-response is no longer send towards the middleware or the middleware does not accept the response or drops the response immediately as invalid. Thereby validity rules/criterions may be set or proposed by the web-se ice-client as well as the mobile web-service-provider.

In a further advantageous embodiment of the invention it is foreseen that a response of the mobile web-service-providers is stored.

This has the advantage that the response of the mobile web-service-provider may send again towards the web-service-client e.g. in case of a system failure or a temporal unavailability of the web-service-clients and thereby ensures that the web-service-client receives the requested web-service-response. In addition it may be attained that similar requests may not be responded by the mobile communication terminal again.

In a further advantageous embodiment of the invention it is foreseen that a response of the mobile web-service-provider is only valid for a certain time.

This has the advantage that outdated web-service-responses are not forwarded towards the web-service-client.

It is a further advantage that the web-service-client may be informed by the middleware that an invalid response is available and/or prompts the client to renew or refresh its request.

The certain time thereby means a temporal criterion for deciding how long a response of the mobile web-service-providers is valid. The certain time may also be a timeframe in which the response remains valid. If the middleware determines that in-between the request of the web-service-client and the response of the mobile web-service-provider the certain time lapsed, the validity check results in that the response of the mobile web-service-provider is not forwarded towards the web-service-client.

In a further advantageous embodiment of the invention it is foreseen, that the response of the mobile web-service-providers is valid only for a certain time, whereby the certain time is comprised within the response as a parameter.

This provides for the advantage that the communication between the mobile web-service-provider and the middleware may be minimized, since the certain time is already comprised as a parameter within the response and may therefore not be requested by the middleware from the mobile web-service-provider if needed.

It is a further advantage that thereby the validity check may be simplified on the middleware since a portion of validity criterion is provided by the mobile web-service-provider and may be used once needed.

A further advantage is that the certain time is provided by the mobile web-service-provider the certain time is dynamic, which means, that any web-service of a mobile web-service-provider provides respectively determines an own certain time, which may differ from the certain time of another web-service of another or the same mobile web-service-provider.

The certain time may also not used and/or may have no relevance if already without the information the validity check by the middleware results in that the response shall not be forwarded towards the web-service-client, e.g. because of the already performed spatial validity check, which provides the result that the response is no longer valid.

It may also be vice versa, i.e. the temporal validity check has provided the result that the response is no longer valid.

Also further validity checks respectively validity check criterions may be foreseen.

A temporal validity check may thereby also be accompanied by a spatial validity check but they may also be checked independently. Furthermore, it is not necessary that both criterions for checking validity of the response, i.e. spatial and temporal criterion, are implemented together, but it may also be implemented only one of these criterions for checking validity of the response.

In a further advantageous embodiment of the invention it is foreseen that a response of the mobile web-service-provider is valid only for a certain time, whereby the certain time is comprised in the request for registering as a parameter.

This provides the advantage that already on receiving the request for registering the certain time for the web-service to be registered and/or the mobile web-service-provider is notified towards the middleware, whereby the middleware may already on registering the web-service and/or the mobile web-service-provider determine whether for the web-service and/or the mobile-web-service provider pending requests may be dropped as outdated and therefore may no longer be transmitted towards the mobile web-service-provider. Thereby the data traffic between the mobile web-service-provider and the middleware may be minimized.

Registering request thereby means that the mobile web-service-provider is registering at the middleware for the first time or in an actualizing manner, to thereby announce its web-service(s) or only some of its web-services towards the middleware, changes of its web-service(s) or to deregister web-service(s) at the middleware. Therefore the mobile web-service-provider may provide necessary data for that the middleware is enabled to determine where to a certain web-service-request of a web-service-client shall be routed and/or how the certain web-service-request shall be treated. In such a request for registering may also comprise validity criterions for a spatial and/or temporal check respectively further validity checks.

In a further advantageous embodiment of the invention it is foreseen that the method further comprises the steps: sending of an authorization request to the web-service-client; receiving an authorization request of the web-service-client; checking of the authorization response, and if the authorization response is successful allow for receiving of web-service-requests of the web-service-client.

This provides the advantage that only the web-service-client which is authorized to request web-service-requests towards the web-service-provider may direct its request towards the middleware. Thereby unauthorized transmission are inhibited which thereby may minimize data traffic between the middleware and the mobile web-service-provider.

Authorizing thereby means that by notification of the particular web-service-client at the middleware it is determined whether the web-service-client is authorized to request web services. To determine and to check authorization it may be possibly necessary that the mobile web-service-provider notifies the middleware of authorization or authorization criterion, based on which the middleware may decide that the web-service-client is allowed to access the requested web-service.

Such criterion may encompass age restrictions, a valid subscription or valid payment of the requested web-service as well as geographic as well as temporal criterions. Further criterions may be foreseen based on which authorization may be determined or decided.

### SHORT DESCRIPTION OF FIGURES

The invention will be further detailed along the figures, which show in

FIG. 1 a schematic arrangement of a “Use Case” Description of a middleware according to aspects of the invention,

FIG. 2 a schematic arrangement of a UML-Sequence diagram of a communication between the mobile web-service-provider and the web-service-client according to aspects of the invention,

FIG. 3 a schematic arrangement of a sequence diagram of a web-service-request and response according to aspects of the invention,

FIG. 4 an exemplary simplified implementation of a possible web-service according to aspects of the invention,

FIG. 5 a schematic arrangement of an UML class diagram according to sub-aspects of an exemplary implementation of the functioning of a mobile web-service-provider, a proxy acting as middleware and communication between those elements according to aspects of the invention, and

FIG. 6 a schematic arrangement of a sequence diagram of a web-service-request and response according to aspects according to another embodiment of the invention.

### DETAILED DESCRIPTION

Before further detailing embodiments of the invention in the following it is noted that the invention is not limited to the described components or described method steps. Furthermore, also the used terminology is not intended as being limiting rather than providing an exemplary character. Although in the following description as well as in the claims singular may be used it is to be assumed that plural is encompassed thereby as well, unless the context is not excluding plural in an explicit manner.

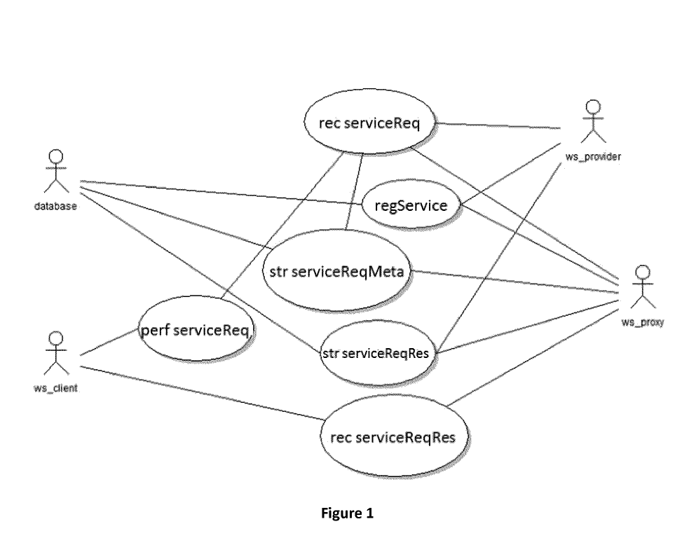

In FIG. 1 a schematic arrangement of a “Use Case” Description of a middleware according to aspects of the invention is shown.

In the example four different parties are shown within the scenario, comprising a web-service-client (ws_client), which requests services, a mobile web-service-provider (ws_provider), which offers services, a web-service-proxy (ws_proxy), which receives requests originating from the client (ws_client), forwards requests towards the provider (ws_provider) and forwards provider's responses towards the client (ws_client), and a database (database), in which data of the client's request (serviceReq) as well as data of the provider's response (serviceReqRes) and potential other data may be provided. Thereby the web-service-proxy (ws_proxy) and the database (database) are core elements of the middleware. Note, the described interactions may be different with respect to different embodiments and not all messages shown in FIG. 1 need to be implemented nor is FIG. 1 meant as being complete. It may also be that further messages may be comprised.

On the provider side, i.e. the web-service-provider (ws_provider), software is operating, which provides the actual web service. In a scenario, in which the web-service is provided by a conventional server-system, the software may be recognized best as an application server, which provides a web-service.

On the consuming side, i.e. the web-service-client (ws_client), software is operating, which conducts the web-service-request, i.e. it is exemplarily a machine-to-machine interaction (MMI).

According to the invention in between the consuming side and the providing side a middleware (ws_proxy, database) is interplaced, whereby the proxy-server (ws_proxy) preferably is implemented having the same interfaces as the mobile web-service-provider (ws_provider). In addition interfaces and methods which are provided by the proxy-server (ws_proxy), e.g. for registering or de-registering web-services or the like, may be accessed via standardized network protocols such as exemplarily SOAP and the description of the interfaces may be based on WSDL.

It is an object of the proxy-server (ws_proxy) to receive client-requests (serviceReq), to store said client-requests if necessary in a database or any other manner, and to await that the mobile web-service-provider (ws_provider) is requesting said requests (serviceReq) and responds with respective responses (serviceReqRes).

Because the proxy-server (ws_proxy) is not acting autonomous and therefore is not trying send the received requests (serviceReq) towards the mobile web-service-provider (ws_provider), i.e. so-called “push-method”, it is possible to circumvene the problems of frequent changing network connections and the thereby experienced change of network addresses of the mobile web-service-providers (ws_provider), since the web-service-provider (ws_provider) is notifying itself, e.g. in predetermined intervals, at the proxy-server (ws_proxy) and requests for requests intended for the provided web-service (serviceReq), i.e. so called “pull-method”. I.e. the mobile web-service-provider (ws_provider) is polling the proxy-server (ws_proxy) for new requests. Thereby neither the web-service-client (ws_client) nor the proxy-server (ws_proxy) needs to know the actual IP-Address of the mobile web-service-providers (ws_provider) beforehand.

It is an object of the database (database) to store the required information of a client-request (serviceReq), to thereby allow the respective web-service to handle the request (serviceReq} and to provide a respective response (serviceReqRes), which in turn may be stored by the database (database) for forwarding it via the proxy-server (ws_proxy) towards the web-service-client (ws_client). In doing so, it is achieved that also the mobile web-service-provider (ws_provider) does generally not know the IP-Address of the web-service-client (ws_client) and thereby solely the proxy-server (ws_proxy) may send the response (serviceReqRes) towards the client (ws_client). This later part may be accomplished conventionally by a “push-method”.

Beyond the described four parties (ws_client, ws_provider, ws_proxy, database) further implementations of embodiments are possible. A mobile web-service-provider (ws_provider) may be enabled to register (regService) an offered service at the proxy-server (ws_proxy). In this case, apart from the mobile web-service-provider (ws_provider) also the proxy-server (ws_proxy) and the database (database) interact.

The proxy-server (ws_proxy) may implement dynamically the interface of the web-service and may store metadata of the web-service-request (serviceReq). Such metadata comprise in particular the method to be requested and the parameter needed therefore.

The database (database) may provide storage for storing parameter values of each method and respective results for each mobile web-service.

A further embodiment is that the mobile web-service-provider (ws_provider) is enabled to receive service-requests (rec serviceReq). In this embodiment also the proxy-server (ws_proxy) participates as the proxy-server is the instance, which receives the requests (serviceReq) submitted by the web-service-clients (ws_client) and stores the required Information in the database (database). In this embodiment further embodiments are encompassed, i.e. the embodiment in which the metadata of the service-request (serviceReq) is stored (str serviceReqMeta) and the embodiment in which the service-request (serviceReq) is executed (perf serviceReq). The embodiment in which the metadata of the service-request (serviceReq) is stored (str serviceReqMeta) interact with the party of the mobile web-service-provider (ws_provider) and the party database (database), whereas the embodiment in which the service-request (serviceReq) is executed (perf serviceReq) only interacts with the web-service-client (ws_client), which provides a substantial advantage with respect to prior art.

The embodiment in which the response (serviceReqRes) is stored (str serviceReqRes) interacts with the parties mobile web-service-provider (ws_provider), proxy-server (ws_proxy) and database (database).

In the last embodiment shown in FIG. 1 response (serviceReqRes) received (rec serviceReqRes) by the proxy-server (ws_proxy) interacts (only) with the parties proxy-server (ws_proxy) and web-service-client (ws_client).

The web-service-client (ws_client) is thereby completely encapsulated with respect to the parties database (database) and mobile web-service-provider (ws_provider), which is particular advantageous, as it ensures that the web-service-client (ws_client) may communicate only with that part of the middleware (ws_proxy), to which requests (serviceReq) are send and wherefrom it receives responses (serviceReqRes). Hence, from client's perspective (ws_client) a mobile web-service-request (serviceReq) resembles any conventional service-request. Therefore, no additional efforts are necessary on the client's side (ws_client) in order to receive service-request-results from a web-service which is operating on a mobile communication terminal.

The method may for example implemented in a so-called middleware (ws_proxy, database), which may be a component of the mobile network or may be a component of another network—even a fix network—being in communication therewith.

Storing of the web-service-request (str serviceReqMeta) may be effected in a central proxy-server (ws_proxy) for that the web-service-requests are not lost and may be provisioned towards the mobile communication terminal which offers the respective web-service (ws_provider) once the respective mobile communication terminal (ws_provider) has notified itself towards the central proxy-server (ws_proxy) and requests for web-service-request (serviceReq).

It is therefore a further advantage, that the mobile web-service-provider (ws_provider) may communicate as web-service-client with the dynamically generated web-service-proxy (ws_proxy) and thereby obviates the need to implement server-side functionality within the respective mobile communication terminal. That means that from network's perspective no server instance needs to be installed in the mobile communication terminal (ws_provider). That means that a web-service-client (ws_client) may not request the web-service of the mobile web-service-providers (ws_provider) in a direct manner, but requests a centrally available proxy (ws_proxy). The web-service operating on the mobile web-service-provider (ws_provider), queries in periodic or non-periodic intervals the proxy-server (ws_proxy), whether there are new messages (serviceReq) relating to the web-service.

Therefore, the problem of a potentially changing network address is resolved, since the mobile web-service-provider (ws_provider) is acting like a client towards the proxy-server (ws_proxy).

The central web-service-proxy (ws_proxy) may thereby exemplarily implement dynamically a proxy (ws_proxy) for any web-service used on a mobile web-service-provider (ws_provider). Thereby, the implemented proxy (ws_proxy) may receive service-requests (serviceReq) as a proxy of the actual service and may buffer (str serviceReqMeta) these requests (serviceReq) along with all necessary data pertaining thereto until the respective web-service of the mobile web-service-provider (ws_provider) requests these requests at the respective proxy (ws_proxy) and receives therefrom these requests (serviceReq) along with the necessary data pertaining thereto. Afterwards, the mobile web-service-provider (ws_provider) may offer the respective web-service and may respond with responses (serviceRegRes) towards the web-service-proxy, for that the web-service-proxy may forward the received responses (serviceReqRes) towards the original requesting web-service-client (ws_client).

Also a response (serviceReqRes) of the mobile web-service-provider (ws_provider) may be stored.

This provides the advantage that the response (serviceReqRes) of the mobile web-service-provider (ws_provider) may be sent again, e.g. in case of a system failure or a temporal unavailability of the web-service-client (ws_client) towards the web-service-client (ws_client) and it may thereby ensure that the web-service-client (ws_client) receives the requested web-service-request (serviceReqRes).

Such a response (serviceReqRes) may be the result of a successful utilization of a web-service, as well as the web-service itself, respectively the data and application or apps that the web-service is offering or administering.

Web-services may encompass communication services as well as any other service, as well as data, applications, apps, result of calculation request, result of a position request, search results, etc.

Data, which is stored (str serviceReqMeta, str serviceReqRes) by the web-service-proxy-server (ws_proxy), may be stored in a file, a relational database (database) or in any other manner which allows for unique retrieval, such as an external database or an internal database.

Storing of data (str serviceReqMeta, str serviceReqRes) may be provided physically on the proxy-server (ws_proxy) itself as well as in a decentralized manner, e.g. in an external database server (database), a cloud or the like.

A mobile web-service-provider (ws_provider) is preferably offered on a so-called Smartphone but may be any other mobile communication terminal, which is able to provide web-services, such as a non-touch-enabled mobile communication terminal or any other computer having dynamic addresses. Preferably a mobile web-service-provider (ws_provider) is offered by a Smartphone or a mobile computer, e.g. in the form of a tablet, a notebook, a pad or similar. Such a mobile computer may also be embodied in an embedded system, which is mobile or fix with respect to a vehicle, e.g. a so-called On Board Unit (OBU) or any other mobile communication terminal or mobile computer, which is able to use a wireless radio-network or a fixed-network, preferably a WLAN network, a WiMAX-network or a WiFi-network, in particular a mobile communication network. A mobile communication network may encompass any mobile communication network such as a GSM, GSM-R, UMTS, LTE, iDEN-Network. In particular these mobile communication technologies may use networks of the second, third, fourth and future generation, and in more general also mobile communication technologies as they are used within the standards of DECT, Bluetooth, or WLAN. In addition also networks are encompassed, which may be used for “short-range-radio” or “ZigBee” or may be suitable for use therewith.

An important criterion for such a communication terminal or such a mobile computer is, that it may log into a network in which the network address may change frequently or is changing frequently, as it is true for mobile communication networks.

A web-service-client (ws_client) may thereby be any network-enabled computer, in particular a mobile communication terminal as described above.

Registering a web-service (regService) means that a web-service provided by a mobile web-service-provider (ws_provider) is announced towards the central proxy-server (ws_proxy), so that this central proxy-server (ws_proxy) may determine when receiving a request (serviceReq) of a web-service-client (ws_client), which web-service is requested by the client and which mobile web-service-provider (ws_provider) provides the web-service. Thereby different mobile web-service-provider (ws_provider) may provide one and the same web-service as well as a mobile web-service-provider (ws_provider) may provide a plurality of different web-services.

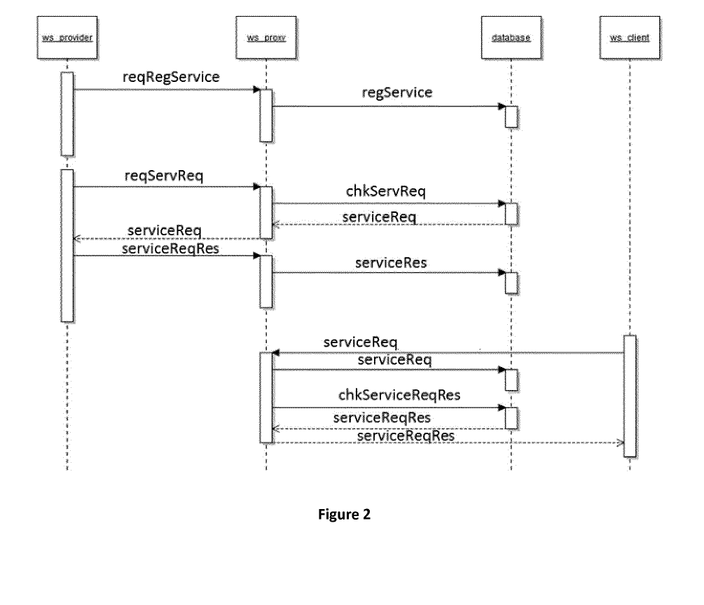

In FIG. 2 a schematic arrangement of a UML-Sequence diagram of a communication between the mobile web-service-provider and the web-service-client according to aspects of the invention is shown.

First a mobile web-service-provider (ws_provider) registers (regService) its web-service at the proxy-server (ws_proxy). As part of this registering process the proxy-server (ws_proxy) generates the necessary data structure in order to be able to store the web-service-requests (serviceReq) intended for the web-service in the database (database). After the mobile web-service-provider (ws_provider) has registered its service, it queries the proxy-server (ws_proxy) in certain intervals, e.g. regular, possibly also permanently or in regular intervals, whether new requests (serviceReq) intended for it are available. The proxy-server (ws_proxy) queries the database (database), whether a new web-service-request (serviceReq) for the requested mobile web-service-provider (ws_provider) is available and if so, it sends the metadata of the available request towards the respective mobile web-service-provider (ws_provider). After having received these data the mobile web-service-provider (ws_provider) executes the service and returns the result as response (serviceReqRes) towards the proxy-server (ws_proxy), which in turn stores the response (serviceReqRes) in the database (database). Afterwards the proxy-server (ws_proxy) is enabled to query (chkServiceReqRes) the response (serviceReqRes) of the respective web-service-request (serviceReq) from the database (database) and to send it towards the respective web-service-client (ws_client).

The method also comprises a receiving step of a request for registering (reqRegService) a web-service of the mobile web-service-provider (ws_provider) and a registration step (regService) of the service. Further the method comprises a receiving step of a web-service-request (serviceReq) with respect to the web-service of a web-service-client (ws_client) and a checking step (chkServiceReqRes) whether a response towards the web-service-request of the web-service-client (ws_client) of the mobile web-service-providers (ws_provider) is available. If a response (serviceReqRes) is available, the response (serviceReqRes) is forwarded towards the web-service-client (ws_client) in another step.

Furthermore, in another step a query (chkServiceReq) whether a request of the mobile web-service-provider (ws_provider) is available may be received. The method may check in a further step whether a web-service-request (serviceReq) of a web-service-client (ws_client) is available, which could not be responded. If a web-service-request (serviceReq) of a web-service-client (ws_client) is available which could not be responded, in a further step the web-service-request (serviceReq) is forwarded towards the mobile web-service-provider (ws_provider).

Thereby it is an advantage that the web-service-request (serviceReq) of a web-service-client (ws_client), which could not be responded instantaneously by the mobile web-service-provider (ws_provider), is buffered for being transmitted towards the mobile web-service-provider (ws_provider) once it notifies again, i.e. the mobile web-service-provider (ws_provider) is available again.

Therefore, it is no longer necessary, that a mobile web-service-provider (ws_provider) is accessible via a network address in a 24/7 manner. Furthermore, a mobile web-service may also be requested even if the network address is changing frequently as it happens frequently when using mobile communication terminals or if a mobile communication terminal is not logged in a network or is even switched off.

Registering request (reqRegService) thereby means that the mobile web-service-provider (ws_provider) is registering at the middleware (ws_proxy) for the first time or in an actualizing manner, to thereby announce its web-service(s) or only some of its web-services towards the middleware (ws_proxy), changes of its web-service(s) or to deregister web-service(s) at the middleware (ws_proxy). Therefore the mobile web-service-provider (ws_provider) may provide necessary data for that the middleware (ws_proxy) is enabled to determine where to a certain web-service-request (serviceReq) of a web-service-client (ws_client) shall be routed and/or how the certain web-service-request (serviceReq) shall be treated. In such a request for registering (reqRegService) may also comprise validity criterions for a spatial and/or temporal check respectively further validity checks.

In a further advantageous embodiment of the invention it is foreseen that the method further comprises the steps: sending of an authorization request to the web-service-client (ws_client); receiving an authorization request of the web-service-client (ws_client); checking of the authorization response, and if the authorization response is successful allow for receiving of web-service-requests of the web-service-client (ws_client) (in FIG. 2 not shown).

This provides the advantage that only the web-service-client (ws_client) which is authorized to request web-service-request (serviceReq) towards the web-service-provider (ws_provider) may direct its request towards the middleware (ws_proxy). Thereby unauthorized transmission are inhibited which thereby may minimize data traffic between the middleware (ws_proxy) and the mobile web-service-provider (ws_provider).

Authorizing thereby means that by notification of the particular web-service-client (ws_client) at the middleware (middleware) it is determined whether the web-service-client (ws_client) is authorized to request web services (serviceReq). To determine and to check authorization it may be possibly necessary that the mobile web-service-provider (ws_provider) notifies the middleware (ws_proxy) of authorization or authorization criterion, based on which the middleware (ws_proxy) may decide that the web-service-client (ws_client) is allowed to access the requested web-service (serviceReq).

Such criterion may encompass age restrictions, a valid subscription or valid payment of the requested web-service as well as geographic as well as temporal criterions. Further criterions may be foreseen based on which authorization may be determined or decided. In addition a number of further criterions are possible based on which a authorization may be determined and/or decided.

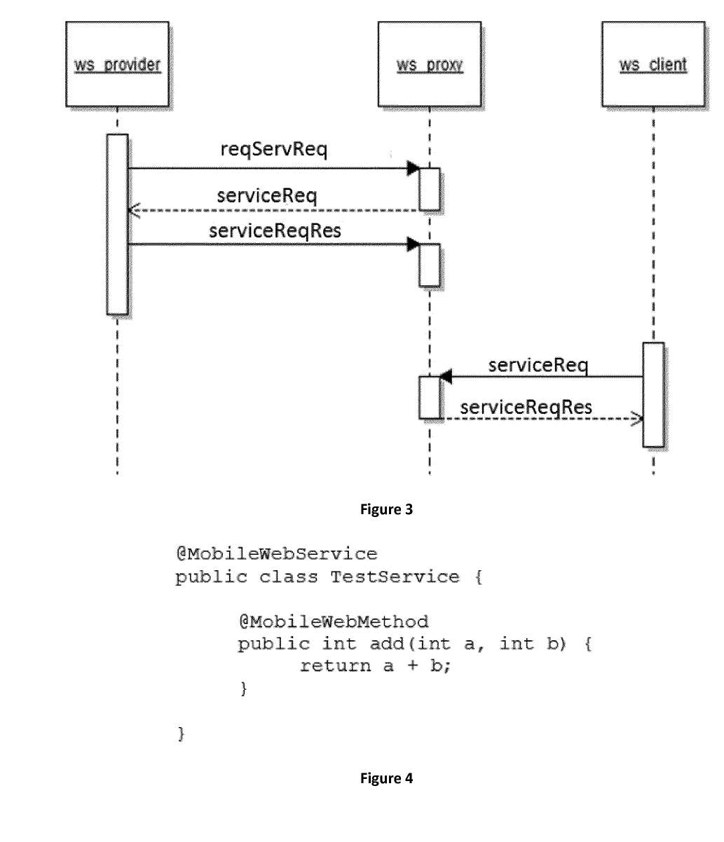

In FIG. 3 a schematic arrangement of a sequence diagram of a web-service-request and response according to aspects of the invention is shown, whereby FIG. 3 shows an exemplary portion of an exemplary UML Sequence diagram similar to FIG. 2 whereby only the communication between the mobile web-service-provider (ws_provider), the proxy-server (ws_proxy) and the web-service-client (ws_client) is shown, whereby the database is integrated into the proxy-server (ws_proxy) and thereby no external communication between the proxy-server (ws_proxy) and the database (database) is necessary.

Before the request (serviceReqRes) of the mobile web-service-provider (ws_provider) of the proxy-server (ws_proxy) is forwarded towards the web-service-client (ws_client), validity of the response (serviceReqRes) may be checked.

This provides the advantage that an outdated or otherwise no longer necessary web-service-response (serviceReqRes) is not forwarded towards the web-service-client.

Before forwarding the response (serviceReqRes) may be checked with respect to temporal and/or spatial validity.

This provides the advantage that no invalid web-service-response (serviceReqRes) is forwarded towards the web-service-client. Invalid may thereby be spatial and/or temporal invalid web-service-response (serviceReqRes).

Thereby spatial validity means that depending on the position of the mobile web-service-provider (ws_provider) a response (serviceReqRes) may get invalid, if the actual position of the mobile web-service-providers (ws_provider) when sending the response (serviceReqRes) of the web-service-request (serviceReqRes) of a client (ws_client) towards the middleware (ws_proxy), is located outside a given area and thereby is rendered position-related irrelevant.

Temporal Validity Check may be based for example on a time stamp when using a proxy-server as middleware (ws_proxy) (so called lifetime), which is provided on the proxy (ws_proxy). It may also exemplarily be a timeframe or the like while the web-service-request (serviceReqRes) remains valid. Furthermore, a countdown may be determined, e.g. 20 min., until which the web-service-response (serviceReqRes) is held to be relevant. It is also possible to provide a unique stamp, so that a web-service-response only is valid once, e.g. by setting the lifetime to 0. Thereby different realizations of validity and validity checks may be possible for a web-service-response (serviceReqRes), which all aim at ensuring that no invalid, i.e. outdated, web-service-responses are forwarded towards to the web-service-client (ws_client).

It is also possible to implement such validity such that only web-service-requests (serviceReq) which are not outdated and/or spatial invalid are forwarded towards the mobile web-service-provider (ws_provider), or in case that validity lapsed of the web-service-response (serviceReqRes) is no longer send towards the middleware (ws_proxy) or the middleware (ws_proxy) does not accept the response or drops the response immediately as invalid. Thereby validity rules/criterions may be set or proposed by the web-service-client (ws_client) as well as the mobile web-service-provider (ws_provider). Preferably the middleware (ws_proxy) determines the spatial and/or temporal validity rules/criterion.

Therefore, it may be foreseen that the response (serviceReqRes) of the mobile web-service-provider (ws_provider) is only valid for a certain time.

This has the advantage that outdated web-service-response (serviceReqRes) is not forwarded towards the web-service-client (ws_client).

A further advantage is that the web-service-client (ws_client) may be informed by the middleware (ws_proxy) that a no longer valid response (serviceReqRes) is available and/or prompts the client (ws_client) to renew or refresh its request (serviceReq).

The certain time thereby means a temporal criterion for deciding how long a response (serviceReqRes) of the mobile web-service-providers (ws_provider) is valid. The certain time may also be a timeframe in which the response (serviceReqRes) remains valid. If the middleware (ws_proxy) determines that in-between the request of the web-service-client (ws_client) and the response (serviceReqRes) of the mobile web-service-provider (ws_provider) the certain time lapsed, the validity check results in that the response (serviceReqRes) of the mobile web-service-provider (ws_provider) is not forwarded towards the web-service-client (ws_client).

It may further be foreseen, that a response (serviceReqRes) of the mobile web-service-providers (ws_provider) is valid only for a certain time, whereby the certain time is comprised within the response (serviceReqRes) as a parameter.

This provides for the advantage that the communication between the mobile web-service-provider (ws_provider) and the middleware may be minimized, since the certain time is already comprised as a parameter within the response (serviceReqRes) and may therefore not be requested by the middleware (ws_proxy) from the mobile web-service-provider (ws_provider) if needed.

It is a further advantage that thereby the validity check may be simplified on the middleware (ws_proxy) since a portion of validity criterion is provided by the mobile web-service-provider (ws_provider) and may be used once needed.

A further advantage is that the certain time is provided by the mobile web-service-provider (ws_provider) the certain time is dynamic, which means, that any web-service of a mobile web-service-provider (ws_provider) provides respectively determines an own certain time, which may differ from the certain time of another web-service of another or the same mobile web-service-provider (ws_provider).

The certain time may also not used and/or may have no relevance if already without the information the validity check by the middleware (ws_proxy) results in that the response (serviceReqRes) shall not be forwarded towards the web-service-client (ws_client), e.g. because of the already performed spatial validity check, which provides the result that the response (serviceReqRes) is no longer valid.

It may also be vice versa, i.e. the temporal validity check has provided the result that the response (serviceReqRes) is no longer valid.

Also further validity checks respectively validity check criterions may be foreseen.

It may also be foreseen that a response (serviceReqRes) of the mobile web-service-provider (ws_provider) is only valid for a certain time, whereby the certain time is comprised within the registration request (reqRegService) as a parameter.

A temporal validity check may thereby also be accompanied by a spatial validity check but they may also be checked independently. Furthermore, it is not necessary that both criterions for checking validity of the response (serviceReqRes), i.e. spatial and temporal criterion, are implemented together, but it may also be implemented only one of these criterions for checking validity of the response (serviceReqRes).

This provides the advantage that already on receiving the request for registering (reqRegService) the certain time for the web-service to be registered and/or the mobile web-service-provider is notified towards the middleware (ws_proxy), whereby the middleware (ws_proxy) may already on registering the web-service and/or the mobile web-service-provider (ws_provider) determine whether for the web-service and/or the mobile-web-service provider (ws_provider) pending requests (serviceReq) may be dropped as outdated and therefore may no longer be transmitted towards the mobile web-service-provider (ws_provider). Thereby the data traffic between the mobile web-service-provider (ws_provider) and the middleware (ws_proxy) may be minimized.

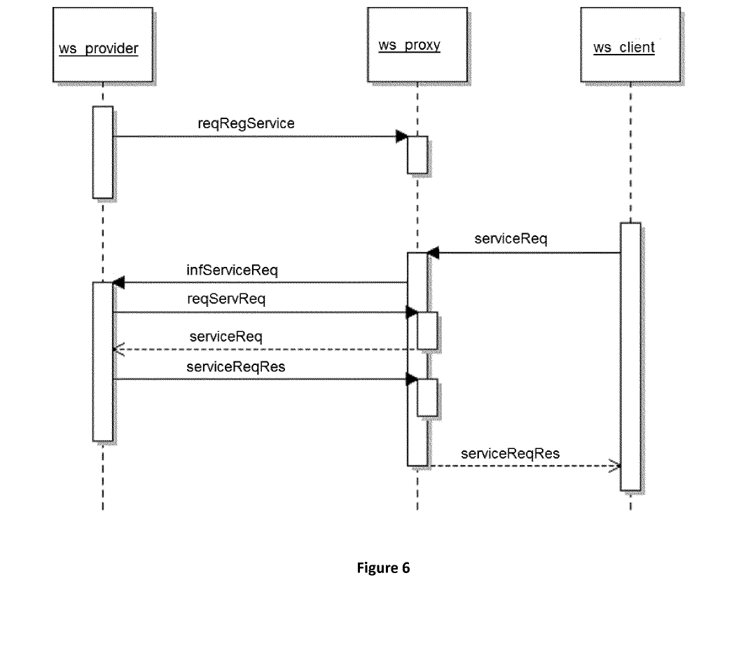

In FIG. 6 a similar portion as shown in FIG. 3 is displayed, whereby the general statements made above are applicable also to this embodiment. The embodiment shown in FIG. 3 is preferably applicable to the situation where the mobile web-service is energy consuming.

There are minor differences, which will be highlighted in the following.

While in the above described embodiments the web-service-provider (ws_provider) is checking a polling manner whether there are new service-requests available in the embodiment shown in FIG. 6, the web-service-provider (ws_provider) is informed by the middleware (ws_proxy) that a new service-request is available. This is performed by sending information relating to the presence of a web-service-request (serviceReq) towards the mobile web-service-provider (ws_provider). As the web-service-provider on receiving the information is aware that a web-service-request is available, it may then request the either the metadata of the service-request (serviceReqMeta) or it may even request the complete service-request (serviceReq) as described above whereupon the proxy-server provides the stored service-request metadata or the complete service-request (ServiceReq) towards the web-service-provider (ws_provider). Depending on the actual implementation, the web-service-provider (ws_provider) may than provide the response conventionally as complete service-request-response (serviceReqRes) or only as the metadata thereof. The proxy-server may than as detailed above store the response or the metadata thereof and/or may send the response (serviceReqRes) towards the requesting client (ws_client).

As the web-service-provider is only acting upon notification energy consumption may be reduced as there is no poling necessary. A further decrease in energy consumption may be achieved if only metadata is exchanged because thereby message size and/or message number may be decreased leading to a further reduction with respect to energy consumption.

Such an implementation may be based on mechanism like Google cloud notification or Windows Push notification service.

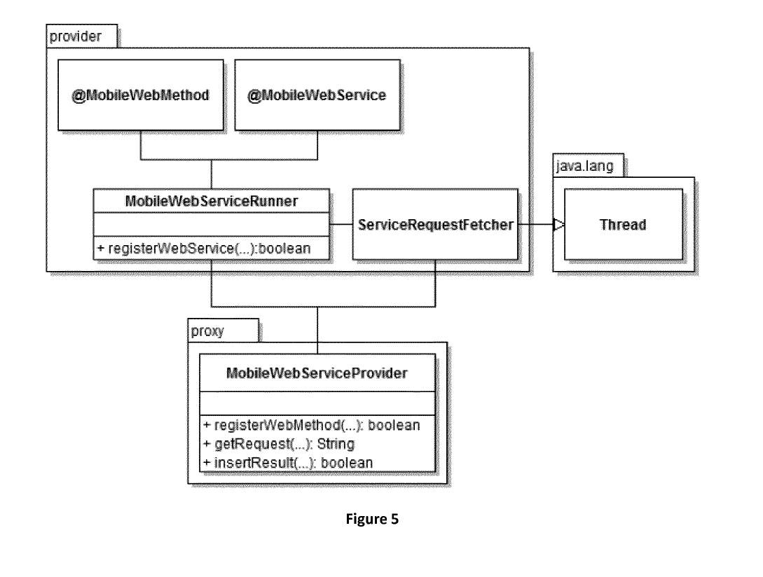

In FIG. 4 an exemplary simplified implementation of a possible web-service according to aspects of the invention is shown.

There, a possible implementation is shown, which relies on JAX-WS (Java API for XML-Based Web-service). The web-service is thereby implements on basis of two notations: @MobileWebService and @MobileWebMethod.

@MobileWebService characterizes a class as a web-service and methods within said class may be characterized as methods being available by means of @MobileWebMethod through the mobile web-service.

FIG. 4 shows exemplary a simple mobile web-service. This web-service provides the result of the addition of two passed variables.

In FIG. 5 a schematic arrangement of an UML class diagram according to sub-aspects of an exemplary implementation of the functioning of a mobile web-service-provider, a proxy acting as middleware and communication between those elements according to aspects of the invention is shown.

FIG. 5 shows relationships between different classes according to an implementation proposal according to the example of FIG. 4. Mainly, the implementation comprises two packages.

On one hand a package is provided, which may be operated on a server, which is accessible from the internet, e.g. via a public IP-Address. This is the proxy-server package, which is shown in the lower portion of the figure. Thereby a class in the package implements the necessary methods for the registration (regService) of the new web-service, for the polling of the web-service towards the proxy-server (ws_proxy) for the service-request metadata (serviceReqMeta) and for the storing of the service-request (serviceReq) in the database (database). All those methods may also be accessible as web-service, so that communication between the instances of the mobile web-service and the proxy-server (ws_proxy) may also be based as web-service.

On the other hand a provider package is provided in which one of the classes is the MobileWebServiceRunner class, on which the web-service is provided. In addition this package may also provide the aforementioned notations @MobileWebMethod, @MobileWebService, which allow to characterize a class. In addition this package implements the ServiceRequestFetcher class. This class is responsible for the ongoing requests of the web-service-providers (ws_provider) with respect to new service-requests (serviceReq). By means of the invention it is enabled to provide web-service also for communication terminal devices, which may be accessible mobile and/or non-permanently.

In the following, it will be shown how the above detailed methods may be used.

A first described example is a betting system.

In the following we will assume an online betting and let's assume that the betting pertains to football or horse races. These betting games are typically characterized by the fact that betting is only possible before the actual game starts, i.e. no real time games.

Thereby a player may place its bet for a football game/horse race to happen at the weekend any time before that date. Thereafter, a web-service (ws_provider) may be started on the player's mobile communication terminal, which allows for receiving the results of the respective bet. Once the result of the bet is available, the organizer of the betting game acting as web-service-client (ws_client) may provide the result towards the web-service (ws_provider).

In contrast, in state of the art solutions the results of the respective bet would have been provided through other means, in particular through Email-Communication or SMS/MMS-notification or by a fix-timed query initiated by the mobile communication terminal.

The solution proposed above is advantageous over the state of the art, since the result is available at the earliest possible time when the web-service-provider (ws_provider) is available and may there be further processed, e.g. for display. Furthermore, by the same mechanism additional bets may be promised towards the subscriber of the mobile communication terminal. As there is no media-break with respect to the betting process and the result provisioning process there is no media change experienced which allows for a better integration as well as customer retention. Although not further detailed, the above described mechanism may also be used in a similar manner for online auctioning systems.

A second described example is an online voting system.

In the following we will assume an online voting system. Thereby online voting system is to be interpreted in a broad manner, i.e. encompassing as well customer surveys. Let's assume an online voting as it is common to many today TV shows like casting shows. There a consumer may while watching a certain television program may vote for a certain candidate. Today to promote votings commercials and/or competitions are placed alongside. By use of the invention it would be possible that a customer actively registers towards a certain television program. Thereafter on the mobile communication terminal or an internet-enabled television set a web-service (ws_provider) may be started which may be used by the producer of the television program (ws_client) to provide voting questions towards the consumer.

The solution proposed above is advantageous over the state of the art, since a registered customer may be contacted in a direct manner and/or at particular times which allows for quite instantaneous reactions. Furthermore, the solution proposed above is advantageous over the state of the art, since the result of the voting is available at the earliest possible time when the web-service-provider (ws_provider) is available and may there be further processed, e.g. for display. Furthermore, by the same mechanism additional votings may be promised towards the customer via its mobile communication terminal or its internet-enabled television. As there is no media-break with respect to the voting process and the result provisioning process there is no media change experienced which allows for a better integration as well as customer retention. Although not further detailed, the above described mechanism may also be used in a similar manner for online ballot systems.

A third described example is a contextualization system.

Based on today's technology mobile communication terminals are enabled by an ever growing number of functionalities. An important functionality is that these mobile communication terminals may acquire knowledge about their localization and/or heading and/or velocity. By use of these data a context of a subscriber of the mobile communication terminal may be acquired. I.e. if a mobile communication terminal is moving rather fast and knowing different positions one may determine that the subscriber is driving on a motorway or on a train. Depending on the context, it would be desirable to provide e.g. context-specific commercials. I.e. it would not make sense to provide a commercial of a nearby roadhouse of the subscriber is on a train while it would also not make sense if a customer is driving by car and the commercial would pertain to the menu in a train's restaurant.

The solution thereto is that the mobile communication terminal is acting as web-service-provider (ws_provider) which provides information allowing for determining the context of the subscriber of the mobile communication terminal. The client (ws_client) in this embodiment may be any application which may use the information. This may be any kind of tracking platform, advertisement platform, and routing platform. In turn any of these platforms may provide data towards the mobile communication terminal, e.g. for display, which is based on the processing of the information.

Apparently, although the invention has been detailed with respect to the methods the methods itself may be embodied in any kind of appropriate hardware or software enabled hardware.

1. A method for providing a web-service on a mobile device as a web-service provider (ws_provider), comprising the steps of:
receiving a request for registering (reqRegService) a web-service from the mobile web-service provider (ws_provider),
registering the service (regService),
receiving a web-service-request (serviceReq) pertaining to the web-service from a web-service-client (ws_client),
checking, whether a response (chkServiceReqRes) in respect to the web-service-request of the web-service-clients (ws_client) is available from the mobile web-service-provider (ws_provider), and if a response (serviceReqRes) is available forwarding the response (serviceReqRes) towards the web-service-client (ws_client),
receiving a request (reqServiceReq) by the mobile web-service-provider (ws_provider) whether a web-service-request (serviceReq) is available,
checking (chkServiceReq), whether a web-service-request (serviceReq) of a web-service-client (ws_client) is available, which could not be responded, if a web-service-request (serviceReq) of a web-service-client (ws_client) which could not be responded is available, forwarding of the web-service-request (serviceReq) towards the mobile web-service-provider (ws_provider).

2. A method for providing a web-service on a mobile device as a web-service provider (ws_provider), comprising the steps of:
receiving a request for registering (reqRegService) a web-service from the mobile web-service provider (ws_provider),
registering the service (regService),
receiving a request (ServiceReq) from a web-service-client (ws_client),
sending an information (infServReq) relating to the presence of a web-service-request (serviceReq) towards the mobile web-service-provider (ws_provider) and in response thereto receiving a request (reqServiceReq) by the mobile web-service-provider (ws_provider) relating to the web-service-request (serviceReq),
sending information relating to the web-service-request (serviceReq) towards the mobile web-service-provider (ws_provider) and in response thereto receiving a response towards said web-service-request (serviceReqRes) for forwarding towards said web-service-client (ws_client).

3. The method according to claim 2, wherein the response (serviceReqRes) is checked with respect to validity before being forwarded.

4. The method according to claim 1, wherein the response (serviceReqRes) is checked with respect to temporal and/or spatial validity before being forwarded.

5. The method according to claim 1, wherein a response (serviceReqRes) of the mobile web-service-provider (ws_provider) is stored e.g. in an external database (database) or an internal database.

6. The method according to claim 1, wherein a response (serviceReqRes) of the mobile web-service-provider (ws_provider) is valid only for a certain time.

7. The method according to claim 1, wherein a response (serviceReqRes) of the mobile web-service-provider (ws_provider) is valid only for a certain time, whereby the certain time is comprised as a parameter within the response (serviceReqRes).

8. The method according to claim 1, wherein a response (serviceReqRes) of the mobile web-service-provider (ws_provider) is valid only for a certain time, whereby the certain time is comprised as a parameter within the request for registering (reqRegService).

9. The method according to claim 1, further comprising the steps of:
sending a authorization request towards the web-service-client (ws_client),
receiving a authorization response from the web-service-client (ws_client),
checking of the authorization response, and if the authorization was successful, allow for receiving of web-service-requests (serviceReq) of the web-service-client (ws_client).

10. The method according to claim 1, wherein the method is performed in the context of a betting or auctioning system.

11. The method according to claim 1, wherein the method is performed in the context of a voting system.

12. The method according to claim 1, wherein the method is performed in the context of a contextualization system.

13. An apparatus for providing a web-service on a mobile device as a web-service provider (ws_provider), comprising:
means for receiving a request for registering (reqRegService) a web-service from the mobile web-service provider (ws_provider),
means for registering the service (regService),
means for receiving a web-service-request (serviceReq) pertaining to the web-service from a web-service-client (ws_client),
means for checking, whether a response (chkServiceReqRes) in respect to the web-service-request of the web-service-clients (ws_client) is available from the mobile web-service-provider (ws_provider), and if a response (serviceReqRes) is available forwarding the response (serviceReqRes) towards the web-service-client (ws_client) via means for sending,
means for receiving a request (reqServiceReq) by the mobile web-service-provider (ws_provider) whether a web-service-request (serviceReq) is available,
means for checking (chkServiceReq), whether a web-service-request (serviceReq) of a web-service-client (ws_client) is available, which could not be responded, if a web-service-request (serviceReq) of a web-service-client (ws_client) which could not be responded is available, forwarding of the web-service-request (serviceReq) towards the mobile web-service-provider (ws_provider) via means for sending.

14. An apparatus for providing a web-service on a mobile device as a web-service provider (ws_provider), comprising:
means for receiving a request for registering (reqRegService) a web-service from the mobile web-service provider (ws_provider),
means for registering the service (regService),
means for receiving a request (ServiceReq) from a web-service-client (ws_client),
means for sending an information (infServReq) relating to the presence of a web-service-request (serviceReq) towards the mobile web-service-provider (ws_provider) and in response thereto said means for receiving are further adapted for receiving a request (reqServiceReq) by the mobile web-service-provider (ws_provider) relating to the web-service-request (serviceReq),
means for sending information relating to the web-service-request (serviceReq) towards the mobile web-service-provider (ws_provider) and in response thereto said means for receiving are further adapted for receiving a response towards said web-service-request (serviceReqRes) and said means for sending are further adapted for forwarding said response towards said web-service-request (serviceReqRes) towards said web-service-client (ws_client).

15. (canceled)
